(19) United States
(12) Patent Application Publication
(10) Pub. No.: US 2012/0012055 A1
(43) Pub. Date: Jan. 19, 2012

(54) Method and Apparatus for the Application of Powder Material to Substrates

(76) Inventors: Michael Newman, Ware (GB); Benjamin Impey, Cambridge (GB); Thomas Henley, Bedfordshire (GB); Douglas Jennings, Hertfordshire (GB); Martin Hallett, Kent (GB)

(21) Appl. No.: 12/884,291

(22) Filed: Sep. 17, 2010

Related U.S. Application Data
(63) Continuation of application No. 10/571,909, filed on Mar. 14, 2006, now abandoned.

(30) Foreign Application Priority Data
Jun. 18, 2003 (GB) 0314188.4

(51) Int. Cl. B05B 5/08; B05B 5/16

(52) U.S. Cl. 118/621; 118/500

(57) ABSTRACT

An apparatus for electrostatically applying a powder material to substrates is disclosed. The apparatus comprises a plurality of platens, each platen being arranged to hold a plurality of substrates, wherein each platen comprises an electrically conducting platen base having a plurality of supports for supporting a plurality of substrates, an electrically conducting platen shield located on the platen base and having a plurality of holes arranged to align with the plurality of supports on the platen base, an insulating coating provided between the platen base and the platen shield, a conveyor for conveying the platens along a path, and an applicator for applying the powder material to the substrates.

### FIELD

Disclosed herein is a method and apparatus for the application of powder material to substrates. The disclosure relates more particularly, but not exclusively, to the electrostatic application of powder material to solid dosage forms.

### Description of Related Art

A “solid dosage form” can be formed from any solid material that can be apportioned into individual units and is, therefore, a unit dose form. A solid dosage form may be, but is not necessarily, an oral dosage form. Examples of pharmaceutical solid dosage forms include pharmaceutical tablets and other pharmaceutical products that are to be taken orally, including pellets, capsules and spherules, and pharmaceutical pessaries, pharmaceutical bougies and pharmaceutical suppositories. Pharmaceutical solid dosage forms can be formed from pharmaceutical substrates that are divided into unit dose forms. Examples of lion-pharmaceutical solid dosage forms include items of confectionery, washing detergent tablets, repellents, herbicides, pesticides and fertilisers.

The electrostatic application of powder material to solid dosage forms is known. Examples of patent specifications describing such applications are WO 96/35516 and WO 02/49771.

When coating solid dosage forms electrostatically with powder it is desirable to position each solid dosage form appropriately in relation to the powder applicator and that requires individual handling of each solid dosage form. Also, if powder is to be applied to opposite faces of the solid dosage form while it is held in a desired position it becomes desirable to be able to turn over the solid dosage form during the handling of it. On a laboratory scale, such handling of the solid dosage forms presents little problem, but if it is desired to apply powder to solid dosage forms at a reasonably high rate, as required for industrial production, the handling of the solid dosage forms becomes a problem.

In WO 96/35516 solid dosage forms are held on a first rotary drum for coating a face of the solid dosage form and are then transferred onto a second rotary drum for coating an opposite face. Such a method has proved workable but there are kisses in production, especially in connection with the loading and unloading of solid dosage forms onto and from the drums, and the transfer of solid dosage forms from one drum to another. There is also a limit to the path length (the circumference of the drum) available for treatment of a face of the solid dosage form and the system is not particularly flexible and cannot therefore easily be adapted from a set up for treating one solid dosage form according to one set of requirements to a set up for treating another solid dosage form according to another set of requirements.

### SUMMARY

There remains a need to provide an improved method and apparatus for the application of powder material to substrates which is satisfied by embodiments disclosed herein.

According to a first aspect disclosed herein there is provided a method of electrostatically applying a powder material to substrates, the method including the steps of:
placing the substrates on platens, each platen holding a plurality of substrates,
conveying the platens in series along a path, and
electrostatically applying a powder material to the substrates held on the platens.

By holding a plurality of substrates on a platen, handling of large numbers of substrates is greatly facilitated because the substrates may be manoeuvred by manoeuvring the platen. That is of particular value when the substrate is fragile, as is commonly the case, for example if the substrate is a pharmaceutical substrate.

The platens may be fixed to the path. Alternatively, the platens may be removable from the path. In that case, preferably, the method further includes the step of bringing the platens to the path along which they are to be conveyed and removing the platens from the path along which they have been conveyed, the bringing and removing of the platens preferably being carried out at a common location along the path.

Preferably, the method further includes the steps of removing the platens from the path at at least one treatment station, treating the substrates held by the platens and returning the platens to the path. By conveying the platens in series along a path but removing them from the path at the at least one treatment station, treating the substrates at the station and thereafter returning the platens to the path to be conveyed further along the path, it becomes possible to carry out the method in a simple way and in a compact space. It is also possible to alter the method and apparatus to allow for a different powder application process and/or a different substrate by altering only a relatively small part of the apparatus.

Where reference is made to a substrate being “on” a platen or where reference is made later to a substrate being “on” a face of a platen, it should be understood that it is within the scope of such a description for the substrate to be housed partly or wholly within a recess in the platen so that it does not necessarily wholly or partly project from the platen.

It will be understood that because the platens are conveyed in series, steps of the method are typically applied only to some, or one, of the platens in turn. For example, substrates may be being placed on one platen while another platen is being removed from the path at a treatment station and substrates on yet another platen are being treated at the treatment station. Thus, whilst substrates on a common platen undergo the steps of the method as set out above in the order set out, substrates on one platen may be at the treatment station while other substrates are being placed on another platen. Preferably the method is carried out continuously.

In an embodiment described below, powder material is electrostatically applied to the substrates at the at least one treatment station and that is the preferred arrangement. It is, however, possible for other treatments to be carried out at the treatment station and for powder material to be electrostatically applied to the substrates as they are conveyed along the path. The electrostatic application of the powder may be carried out in a single step or in a series of steps. WO 02/49771, the contents of which are incorporated herein by reference, describes a method and apparatus for applying a powder material electrostatically in which the application of electrostatically charged powder material to the substrate is continued until an electric field between the source of powder material and the substrate is so small that the driving of the powder material by the electric field onto the substrate is substantially terminated. When such an approach is adopted, it may be especially desirable to have a plurality of steps of applying powder material electrostatically.

The method preferably further includes the step of fusing the powder material after it is electrostatically applied. Whilst the fusing can be carried out at the at least one treatment station, the step of fusing the powder material preferably takes place after the platens are returned to the path.

After the step of conveying the platens in series along a path, the method preferably includes the steps of
removing the platens from the path at a first treatment station, applying powder material electrostatically to first faces of the substrates, and returning the platens to the path;
conveying the returned platens further along the path;
removing the platens from the path at a second treatment station, applying powder material electrostatically to second faces of the substrates, and returning the platens to the path; and
conveying the platens returned from the second treatment station still further along the path.

By adopting such a method, opposite faces of the substrate may be coated in the method. The method may further include the step of fusing the powder material after it is electrostatically applied. A first fusing step may take place when the returned platens are conveyed further along the path and prior to removing the platens from the path at the second treatment station, and a second fusing step may take place when the returned platens have been returned from the second treatment station and are conveyed still further along the path.

The fusing step may comprise conveying the platens past a plurality of fusing devices arranged in series along the path. Although providing a plurality of fusing devices increases the space required for fusing, that may be desirable in order to allow the substrates to be conveyed along the path at a speed that is desirable from other points of view.

The platens may be conveyed along the path in a series of steps, preferably in unison. The platens may all be moved together one step and may then remain stationary at their new location before again being moved another step. Preferably, the periods during which the platens remain stationary are longer than the periods during which they move. Where there are steps of removing the platens from the path at at least one treatment station and returning the platens to the path, these steps are preferably carried out during periods when the platens are stationary.

The path along which the platens are conveyed is preferably substantially horizontal. The platens may move a substantial distance vertically at the at least one treatment station. Such a combination of horizontal and vertical movement of the platens reduces the floor area required to carry out the method.

Whilst it is possible for the platens to be conveyed from one end to the other of a path, it is preferred that they are conveyed around an endless path. Preferably the method further includes the steps of bringing platens to the path along which they are to be conveyed and removing platens from the path along which they have been conveyed, the bringing and removing of the platens being carried out at a common location along the path. In the case where the platens move around the path in a series of steps, it is preferred that the bringing and removing of the platens is carried out when the platens are stationary.

Preferably the method further includes, after the step of removing the platens from the path at the at least one treatment station and prior to the step of returning the platens to the path, the following steps:
operatively coupling the platens to a first drive mechanism and transporting the platens by driving the first drive mechanism,
decoupling the platens from the first drive mechanism, operatively coupling the platens to a second drive mechanism and transporting the platens by driving the second drive mechanism, and
decoupling the platens from the second drive mechanism.

We have found that by providing two drive mechanisms it becomes possible to arrange in a simple fashion for the platens to be driven at different speeds in different regions of a treatment station even when the platens are following a single endless path through the treatment station.

The first and second drive mechanisms, which may comprise endless drive members, for example toothed belts, are preferably disposed along adjacent paths, adjacent to which the platens travel at the at least one treatment station.

One of the first and second drive mechanisms preferably drives continuously at a substantially constant speed, v. It will be understood that the reference to a speed ‘v’ is simply used as a designation of that speed, rather than to indicate any particular speed. The other of the first and second drive mechanisms preferably drives, during a first phase, at the speed v. The steps of decoupling the platens from the first drive mechanism and coupling the platens to the second drive mechanism preferably takes place during the first phase of driving of the other of the first and second drive mechanisms. During that phase the first and second drive mechanisms are driving at the same speed and a smooth transfer is therefore facilitated. It is also preferred that the other of the first and second drive mechanisms drives, during a second phase, at a speed u, where speed u is greater than speed v. In that case the platens can be driven at a higher speed by the second drive mechanism. Also, the other of the first and second drive mechanisms preferably drives, during a third phase, at zero speed. It is advantageous that the steps of removing the platens from the path at the at least one treatment station and returning the platens to the path take place during the third phase of driving of the other of the first and second drive mechanisms.

In a preferred embodiment described below, the method includes, after the step of removing the platens from the path at the at least one treatment station and prior to the step of returning the platens to the path, the following steps:
operatively coupling the platens to the second drive mechanism while it is driving at zero speed,
driving the platens with the second drive mechanism at a speed v,
decoupling the platens from the second drive mechanism, operatively coupling the platens to the first drive mechanism and continuing to drive the platens at the speed v,
decoupling the platens from the first drive mechanism, operatively coupling the platens to the second drive mechanism and continuing to drive the platens at the speed v,
driving the platens with the second drive mechanism at a speed u, greater than v,
driving the platens at zero speed with the second drive mechanism and decoupling the platens from the second drive mechanism.

The method preferably includes the following steps:
positioning an empty second platen with a face of the second platen adjacent to a face of a first platen holding a plurality of substrates on the exposed face;
releasing the plurality of substrates from the first platen and holding the released substrates on the face of the second platen, and
separating the adjacent faces of the first and second platens.

The steps just described enable faces of the substrates that were previously positioned on the exposed face of the first platen to become fully exposed on the second platen and vice versa. Also, the steps enable this to be accomplished in a simple and secure operation which need not expose the substrates to any large impacts, so that even fragile substrates can avoid being damaged.

It is possible for the releasing and holding steps to be carried out without any physical movement of the platens: for example, the substrates may be released from one platen by halting a low pressure suction applied to the platen, and may be held on the second platen by applying a low pressure suction to the second platen. It is preferred, however, to make use partly or wholly of gravitational forces and it is therefore preferred that the face of the first platen faces upwardly when the face of the second platen is positioned adjacent to it, and the steps of releasing the plurality of substrates from the first platen and holding the released substrates on or in the face of the second platen are carried out at least partly by inverting the first and second platens. The inverting of the first and second platens is preferably carried out by arcuate movement of the first and second platens around approximately half a revolution. The arcuate movement may be movement around a substantially horizontal axis.

The step of releasing the plurality of substrates from the first platen preferably includes vibrating the first platen. Such vibration is of assistance in the event that any of the substrates are inclined to adhere to the first platen. There can also be advantage in vibrating the second platen since that can help the substrates to settle in correct positions on the second platen. Therefore, the steps of releasing the plurality of substrates from the first platen and holding the released substrates on the face of the second platen preferably includes vibrating the first and second platens in unison.

The first and second platens may be substantially the same. In that case powder can be electrostatically applied to opposite faces of the substrates in the same way and substantially the same coating obtained on the opposite faces (which may join along a middle line of the substrate to provide a completely coated substrate). Alternatively the first and second platens may differ and the positions of the substrates on the second platen may differ from the positions of the substrates on the first platen. In the latter case coatings having different characteristics can be applied to opposite faces of the substrates. For example, the coating to one face may extend also over all or part of the side walls of a substrate while the coating to the other face may be limited to that face alone.

Preferably, the method further includes the step of fusing the powder material after it is electrostatically applied, in which the fusing is carried out with infra-red (“IR”) radiation, characterised in that the wavelength of the radiation used corresponds to a significant peak present in the IR spectrum of the coating material. Preferably that peak is not present to any significant extent in the IR spectrum of the substrate.

Whilst, it is preferable to fuse the powder material with IR radiation, other forms of electromagnetic radiation may be used. Usually the change in the coating upon heating will simply be a physical change from a powder to a liquid and then, on cooling, to a continuous solid coating, but alternatively, for example, the powder coating may comprise a polymer which is cured during the treating step, for example by irradiation with energy in the gamma, ultra-violet or radio frequency bands, to form a continuous cross-linked polymer coating.

It is important that the powder can be fused or treated without degradation of the substrate. If an infra-red source is used, this would tend to be one of low wavelength, often with peak values below 2 μm, as it would be expected that, for the same amplitude, the lower the wavelength (and therefore the higher the frequency) the faster the coating can be melted, so there would be less chance of heat transfer to the substrate. Also, the faster the coating can be melted, the faster the method can be carried out.

In one embodiment, the fusing is carried out with IR radiation of wavelength in the range of from 3-6 μm.

By the use of such radiation it is possible to fuse the coating in an especially efficient manner without adversely affecting the active material present; that is, the fusible material in the coating is heated preferentially and this benefit can outweigh the potential disadvantages of using such a relatively high wavelength of radiation.

The 3-6 μm range corresponds to the carbonyl region in the IR. When, as is advantageous, the fusible material for the powder coating contains carbonyl, whether as a CO group on its own or as part of a moiety, e.g. in an ester, irradiation in the 3-6 μm region facilitates heating and melting of the fusible material. Further, use of wavelengths in the 3-6 μm range for relatively short periods leads to preferential heating of the fusible coating material, rather than the substrate itself. The use of radiation in the 3-5 μm range should especially be mentioned.

The radiation used may, for example, span the specified region and may be substantially confined to that region, or may span a portion thereof, with no substantial radiation being used outside the region. If desired, however, the peak radiation may fall in the 3-6 μm region, with a proportion of the radiation falling outside the region. The use of a wavelength band with substantially no component below 3 μm should especially be mentioned. If desired, a narrow wavelength band may be used.

Preferably each platen comprises a platen base having a plurality of supports for supporting a plurality of substrates, and an electrically conducting platen shield located on the platen base and having a plurality of holes arranged to align with the plurality of supports on the platen base.

The presence of an electrically conducting platen shield is of advantage during the electrostatic application of powder material.

The platen base is preferably electrically conducting and an electric potential difference is preferably established between the platen base and the platen shield during electrostatic application of the powder material to the substrates. In that case it becomes possible to control the electrostatic application of the powder more effectively. Our corresponding British patent application No 0201036.1 provides details of a suitable shield configuration and how that can be of advantage and the contents of that specification is incorporated herein by reference.

The supports are preferably connected to a low pressure source during at least part of the method to retain the substrates on the platens. The connection to a low pressure source results in an airflow through and/or around the substrates thereby serving to retain them, or assist in retaining them, on the platens. Such a retention effect is especially valuable if it is desired to support the substrates with the platens above the substrates, as may be desirable during the electrostatic application of powder material to the substrates. A flow of air through the substrates and into the platens may also be of advantage during fusing of powder applied to the substrates because it may avoid bubbling of the powder coating as it is fused.

The substrates to which powder material is applied may take various forms: they may be pharmaceutical substrates and/or solid dosage forms; in the case where the substrate is a pharmaceutical solid dosage form, it may especially, but not exclusively, be a tablet core.

According to the first aspect there is also provided an apparatus for electrostatically applying a powder material to substrates, the apparatus comprising:
a plurality of platens, each platen being arranged to hold a plurality of substrates,
a conveyor for conveying the platens along a path, and
an applicator for applying the powder material to the substrates.

Preferably, the apparatus further includes at least one treatment station arranged to remove the platens from the conveyor, to treat the substrates held by the platens and to return the platens to the conveyor for conveying the platens further along the path.

The apparatus defined above is suitable for carrying out the method according to the first aspect and may therefore include features corresponding to any of the preferred steps of that method. Amongst other features, the at least one treatment station may comprise an apparatus for electrostatically applying powder material to the substrates. The apparatus may further include a fusing assembly for fusing powder material electrostatically applied to the substrates at the at least one treatment station. The fusing assembly may be provided on a part of the path along which the conveyor is arranged to convey the platens after they are returned from the at least one treatment station. A first apparatus for applying powder material to a first face of each substrate may be arranged to remove the platens from the conveying means, to apply powder material electrostatically to substrates held by the platens and to return the platens to the conveying means for conveying the platens further along the path. The apparatus may further include a first fusing assembly for fusing powder material electrostatically applied to the substrates at the first apparatus and a second fusing assembly for fusing powder material electrostatically applied to the substrates at the second apparatus. The first fusing assembly may be provided on a part of the path along which the conveyor is arranged to convey the platens after they are returned from the first apparatus and the second fusing assembly may be provided on a part of the path along which the conveyor is arranged to convey the platens after they are returned from the second apparatus. The or each fusing assembly may comprise a plurality of fusing devices disposed in series along the path. The conveyor may be arranged to convey the platens along a substantially horizontal path. The conveyor may be arranged to convey the platens along an endless path. The apparatus may further include a platen transfer station for introducing platens to the conveyor and removing platens returning to the platen transfer station after they have been conveyed around the path. The platens may be arranged to move a substantial distance vertically at said at least one treatment station. The apparatus may further include a device for positioning an empty second platen with a face of the second platen adjacent to a face of a first platen holding a plurality of substrates on the face of the first platen, for releasing the substrates from the first platen and holding the released substrates on the face of the second platen, and for separating the adjacent faces of the first and second platens. The device may be arranged to position an empty second platen with a lower face of the empty platen adjacent to an exposed upper face of a first platen holding a plurality of substrates on the exposed face, to invert the first and second platens and to remove the first platen from the second platen. The first and second platens may be mounted for arcuate movement along a common path extending around approximately half a revolution. The device may include a vibrator for vibrating the first platen. The device may include a vibrator for vibrating the first and second platens in unison. The first and second platens may be substantially the same or they may differ such that the position of the substrates on the second platen can differ from the positions of the substrates on the first platen. There may be further provided at the at least one treatment station a drive arrangement for driving the platens through the treatment station at a varying speed, the drive arrangement comprising a first drive mechanism for driving the platens through a first portion of the treatment station, a second drive mechanism for driving the platens through another portion of the treatment station and at least one transfer mechanism for decoupling the platens from one drive mechanism and coupling them to the other drive mechanism. The first and second drive mechanisms may comprise endless drive members. The endless drive members may be toothed drive belts. The first and second drive mechanisms may be disposed along adjacent paths. One of the first and second drive mechanisms may be arranged to operate at constant speed. The other of the first and second drive mechanisms may be arranged to operate at a variety of speeds. Said at least one transfer mechanism may comprise a first transfer mechanism for decoupling the platens from the first drive mechanism and coupling them to the second drive mechanism and a second transfer mechanism for decoupling the platens from the second drive mechanism and coupling them to the first drive mechanism. The transfer mechanism may be arranged to effect transfer by camming engagement of a projecting member mounted for movement with a platen in a guide track provided at the treatment station. There may be further provided a device for fusing the powder material after it is electrostatically applied, in which the fusing is carried out with infra-red radiation, characterised in that the wavelength of the radiation used corresponds to a significant peak present in the infra-red spectrum of the coating material but, preferably, not present to any significant extent in the infra-red spectrum of the substrate. There may alternatively, or in addition, be provided a device for fusing the powder material after it is electrostatically applied, in which the fusing is carried out with infra-red radiation of wavelength in the range of from 3-6 μm. Each platen may comprise a platen base having a plurality of supports for supporting a plurality of substrates, and an electrically conducting platen shield located on the platen base and having a plurality of holes arranged to align with the plurality of supports on the platen base. The base of the platen may be electrically conducting and an insulating coating may be provided between the platen base and the platen shield. The insulating coating may also be provided on holes in the platen shield. This insulating coating may be integral with the platen base and the platen shield. Insulating rings may be located in the holes in the platen shield. The shield may be adjacent to but slightly spaced from the platen base and the spacing of the shield from the platen base may be adjustable. The conveyor may include a plurality of platen supports and the platens may be detachably connectable to the supports, There may be provided at the at least one treatment station a plurality of carriages arranged to travel along a predetermined path and the platens may be detachably connectable to the carriages.

The methods and apparatus described above comprise, in some of their preferred forms, certain method steps and certain apparatus which are in themselves novel and inventive. Thus in addition to the first aspect as defined above, there are other aspects as set out below.

According to a second aspect, there is provided a method of electrostatically applying a powder material to opposite faces of each of a plurality of substrates, the method comprising the steps of:
providing a first platen and a second platen, each being arranged to hold a plurality of substrates,
providing a plurality of substrates on a face of the first platen,
electrostatically applying powder material to exposed first faces of each of the plurality of substrates on the first platen,
positioning a face of the second platen adjacent to the face of the first platen,
releasing the plurality of substrates from the first platen and holding the released substrates on the face of the second platen,
separating the adjacent faces of the first and second platens, and
electrostatically applying powder material to exposed second faces of each of the plurality of substrates on the second platen.

According to the second aspect of the invention, there is also provided an apparatus for electrostatically applying a powder material to substrates, the apparatus comprising:
a series of platens, each platen being arranged to hold a plurality of substrates on a face of the platen,
a conveyor for conveying the platens along a path,
a station for electrostatically applying a powder material to exposed faces of substrates held on platens, and
a transfer device for positioning an empty second platen with a face of the empty platen adjacent to a face of a first platen holding a plurality of substrates on the face of the first platen, for releasing the substrates from the first platen and holding the released substrates on the face of the second platen, and for separating the adjacent faces of the first and second platens.

According to a third aspect, there is provided a method of electrostatically applying a powder material to a plurality of substrates, the method including, in addition to the electrostatic application of powder material, the steps of
placing the substrate on platens, each platen holding a plurality of substrates,
operatively coupling the platens to a first drive mechanism and transporting the platens by driving the first drive mechanism,
decoupling the platens from the first drive mechanism, operatively coupling the platens to a second drive mechanism and transporting the platens by driving the second drive mechanism, and
decoupling the platens from the second drive mechanism.

According to the third aspect, there is also provided an apparatus for electrostatically applying a powder material to substrates, the apparatus comprising:
a series of platens, each platen being arranged to hold a plurality of substrates on a face of the platen,
an applicator for electrostatically applying the powder material to the substrates, and
a drive arrangement for driving the platens through the apparatus at a varying speed, the drive arrangement comprising a first drive mechanism for driving the platens through a first portion of the apparatus, a second drive mechanism for driving the platens through a second portion of the apparatus and at least one transfer mechanism for decoupling the platens from one drive mechanism and coupling them to the other drive mechanism.

According to a fourth aspect, there is provided a method for fusing a powder coating on a substrate, in which fusing is carried out with infra-red radiation, characterised in that the wavelength of the radiation used corresponds to a significant peak present in the infra-red spectrum of the coating material but not present to any significant extent in the infra-red spectrum of the substrate.

According to the fourth aspect, there is also provided a method for fusing a powder coating on a substrate, in which fusing is carried out with infra-red radiation of wavelength in the range of from 3-6 μm.

According to the fourth aspect, there is also provided an apparatus for fusing powder coating on a substrate, in which the apparatus is arranged to carry out the fusing with infra-red radiation, characterised in that the wavelength of the radiation used corresponds to a significant peak present in the infra-red spectrum of the coating material but not present to any significant extent in the infra-red spectrum of the substrate.

According to the fourth aspect, there is also provided an apparatus for fusing powder coating on a substrate, in which the apparatus is arranged to carry out the fusing with infra-red radiation of wavelength in the range of from 3-6 μm

According to a fifth aspect, there is provided a platen for holding a plurality of substrates to which powder material is to be electrostatically applied, the platen comprising:
a platen base having a plurality of supports for supporting a plurality of substrates and
an electrically conducting platen shield located on the platen base and having a plurality of holes arranged to align with the plurality of supports on the platen base.

It should be understood that features described above as essential or optional in respect of one aspect may also be incorporated in another aspect. For example, a method according to the third aspect may incorporate the features described as essential to the method of the first aspect or any of the features described as optional in the method of the first aspect.

### BRIEF DESCRIPTION OF THE DRAWINGS

An embodiment will now be described with reference to the accompanying drawings of which

FIG. 1 is a perspective view of a solid dosage form to be coated;

FIG. 2a is a plan view of an assembled platen;

FIG. 2b is an end elevation view of an assembled platen;

FIG. 2c is a side elevation view of an assembled platen;

FIG. 2d is a sectional view of the assembled platen through the line IID-IID on FIG. 2a;

FIG. 2e is a sectional view of the assembled platen through the line IIE-IIE on FIG. 2a;

FIG. 3a is a plan view of a platen base;

FIG. 3b is an end elevation view of a platen base;

FIG. 3c is a side elevation view of a platen base;

FIG. 3d is a sectional view of the platen base through the line III-III on FIG. 3a

FIG. 4 is a perspective view of a platen shield;

FIG. 5 is a plan view of a coating apparatus;

FIG. 6 is a perspective view of the coating apparatus shown in FIG. 5;

FIG. 7 is an enlarged view of the entry and exit region of the coating apparatus;

FIG. 8a is an elevation view of the first developing machine;

FIG. 8b is a plan view of the first developing machine;

FIG. 9 is a perspective view of a belt flight;

FIG. 10 is a perspective view of a belt changer;

FIG. 11a is a perspective view of a belt transfer block;

FIG. 11b is a plan view of the belt transfer block of FIG. 11a;

FIG. 12 is a sectional view of a developer;

FIG. 13 is a side view of the first fusing region;

FIG. 14 is a sectional view of the first fusing region along the line XIV-XIV in FIG. 13;

FIG. 15 is a plan view of the inverting mechanism; and

FIG. 16 is a perspective view of part of the inverting mechanism.

### DETAILED DESCRIPTION OF SPECIFIC EMBODIMENTS

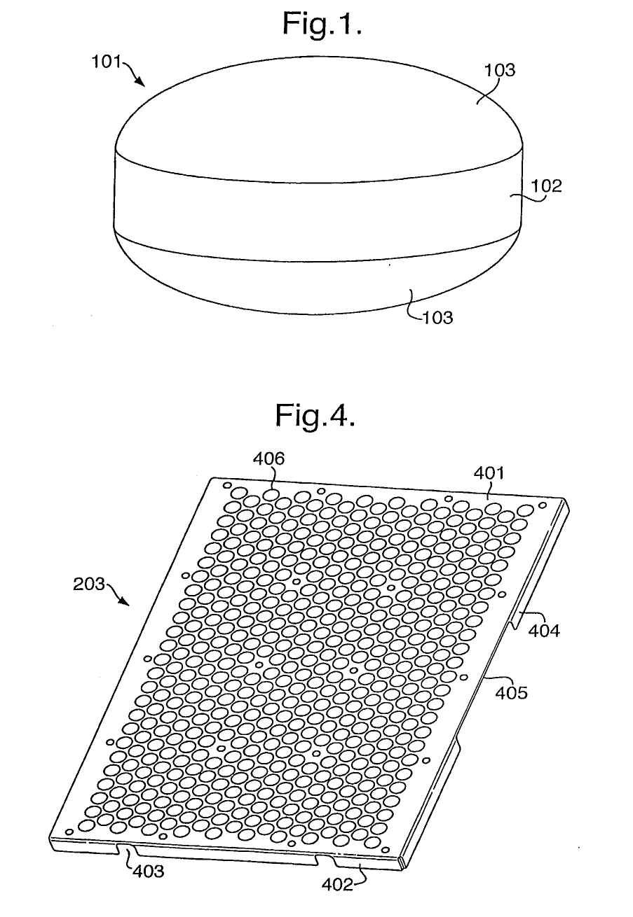

FIG. 1 is a perspective view of a solid dosage form 101 which is to be coated in the coating apparatus disclosed herein. In this example, the solid dosage form is a pharmaceutical tablet with a circumferential surface 102 and two domed end surfaces 103. Of course, the solid dosage form could be any shape which is appropriate for its particular application.

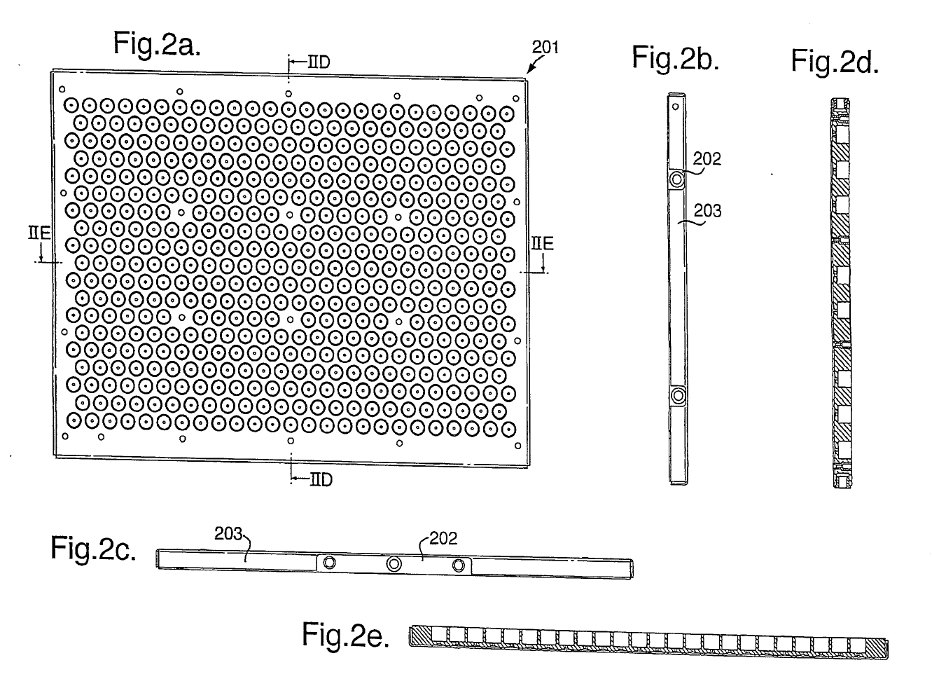

FIGS. 2a, 2b, 2c, 2d and 2e show a platen 201 designed to hold solid dosage forms (like that shown in FIG. 1) which are to be coated in the coating apparatus. In this embodiment, the platen 201 comprises two separate parts: a platen base 202 and a platen shield 203. However, this may not be the case and an alternative embodiment is described below.

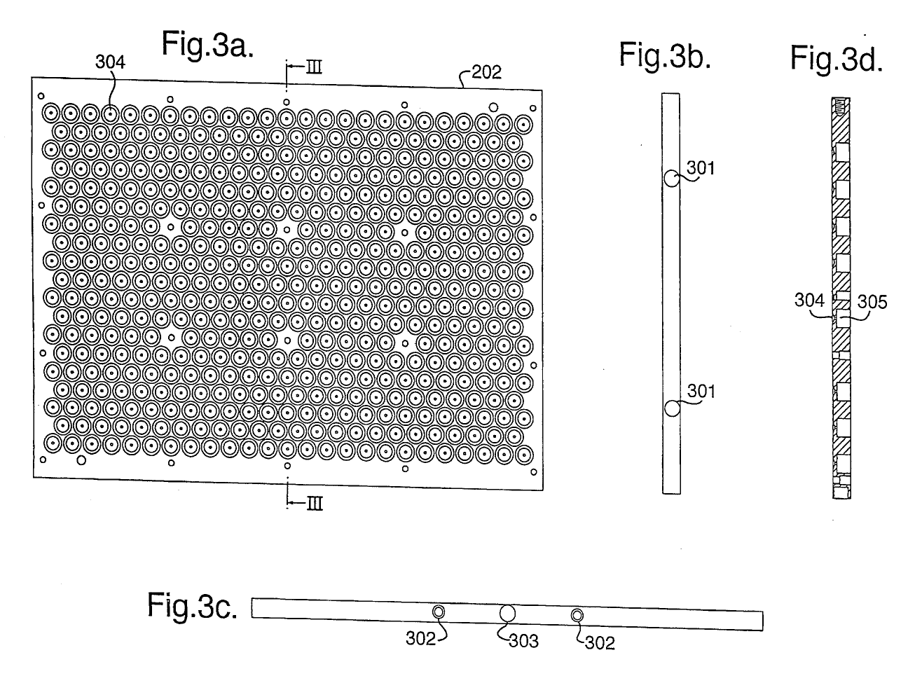

The platen base 202 is shown in more detail in FIGS. 3a, 3b, 3c and 3d. FIG. 3a is a plan view of the platen base 202, FIGS. 3b and 3c are elevation views of the platen base 202 and FIG. 3d is a sectional view along the line III-III of FIG. 3a. It can be seen from FIGS. 3b and 3c that there are two holes 301 in the end of each platen base 202 and three holes (two outer holes 302 and one central hole 303) in the side of each platen base 202. The holes 301, 302, 303 are for releasably securing the platen 201 to the coating apparatus at various stages in the coating process, as will be described in more detail later.

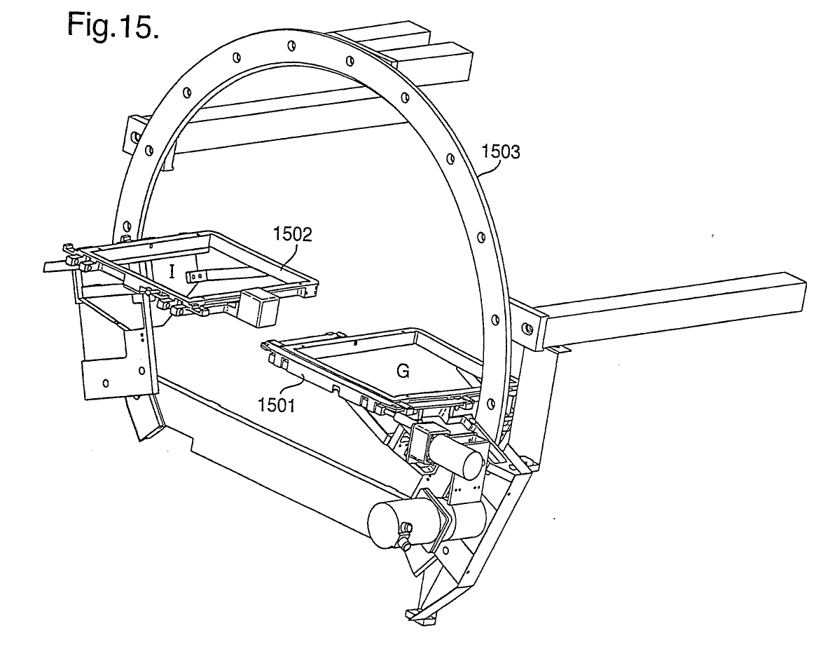

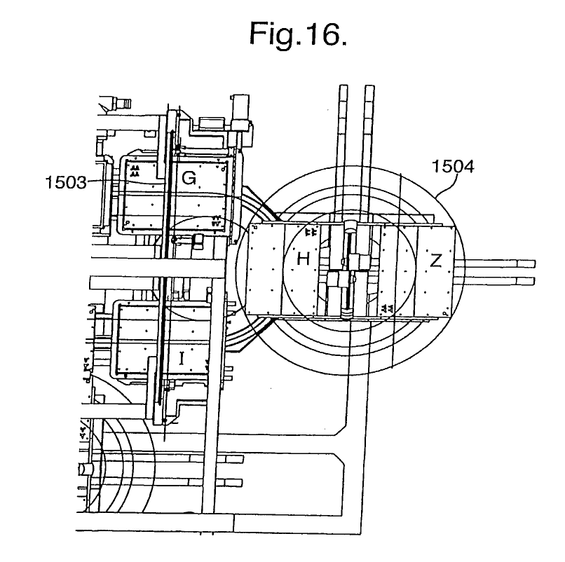

As will be seen from FIG. 3a, in the top surface of the platen base 202 are a multiplicity of (in this particular example about 460) regularly spaced circular hollows 304 for receiving the solid dosage forms 101 to be coated. The hollows 304 in the platen base in FIG. 3a are circular but of course could be any shape to match the shape of the solid dosage forms to be coated. The depth of the hollows can be chosen such that the height of the solid dosage form 101 sits at a selected height relative to the top surface of the platen base 202. Selection of that height can partly or fully determine how much of the circumferential surface 101 of the solid dosage forms is coated at any one time, as explained further below with reference to FIGS. 15 and 16.

FIG. 3d is a sectional view of the platen base 202 along the line III-III in FIG. 3a. In this embodiment, each hollow 304 in the platen base is curved in cross section in order to match a domed end surface 103 of the solid dosage form 101. The cross section need not be curved and this may depend on the shape of the solid dosage form to be coated. In fact, the cross section need not exactly match the shape of the solid dosage form. For example, the hollows 304 may be conical even with a domed solid dosage form. At the centre of each hollow 304 is a passageway 305 which connects the hollows 304 via the interior of the platen base to a vacuum supply as will be described in more detail later.

The platen shield 203 is shown in more detail in FIG. 4. The platen shield 203 comprises a top surface 401, two end edge surfaces 402 (only one of which can be seen in FIG. 4) and two side edge surfaces 404 (only one of which can be seen in FIG. 4). In each end edge surface 402 there are two small recesses 403 and in each side edge surface 404 there is one large recess 405. In the top surface 401, there are a multiplicity of regularly spaced circular holes 406 which are designed to line up with the hollows 304 in the platen base 202 when the platen is assembled.

FIGS. 2a, 2b, 2c, 2d and 2e show the assembled platen. The platen shield 203 is located over the platen base 202 and is secured to the platen base with fixing means e.g. screws (not shown). The two small recesses 403 in each end edge surface 402 of the platen shield 203 are located to expose the holes 301 in the end of the platen base 202 when the platen is assembled, Similarly, the large recess 405 in each side edge surface 404 of the platen shield 203 is located to expose the outer holes 302 and the central hole 303 in the side of the platen base 202. The holes 406 in the platen shield 203 are aligned with the hollows 304 in the platen base 202.

When the platen is in use, the solid dosage forms 101 are located in the hollows 304 on the platen base 202. The holes 406 in the platen shield 203 have a diameter slightly larger than that of the solid dosage forms 101 to be coated such that there is a small gap between the outside of the solid dosage form 101 and the inside of the hole 406. Typically, in this example, the diameter of each hole 406 is about 10.4 mm and the diameter of each solid dosage form is about 10.1 mm so that the gap is of the order of 100 to 150 μm. When the solid dosage forms come into the developing machine, the platen base 202 and the solid dosage forms 101 are earthed. The powder material is positively charged and is attracted to the earthed solid dosage forms. The platen shield 203 is also positively charged so that the powder material is repelled from the platen shield 203 and only coats the exposed surfaces of the solid dosage forms. The use of a shield of this type is the subject of our British patent application No 0201036.1, referred to above.

The underside of the platen shield 203 is coated with an insulating coating in order to separate the earthed solid dosage forms 101 and platen base 202 from the positively charged platen shield 203. The insulating coating preferably should not extend onto the top surface 401 or any of the edge surfaces 402, 404 of the platen shield 203, since this could result in electrostatic charges on the surfaces of the shield which will not dissipate. This could result in the positively charged powder material being attracted onto the platen shield 203. As mentioned above, there is a small gap between the outside of the solid dosage forms and the inside of the holes 406. That gap is typically 100 to 150 μm and, since the solid dosage form 101 is earthed and the platen shield 203 is positively charged, there is a possibility of sparking across the gap. With this platen design, in order to prevent this, small insulating annular rings (not shown) may be fitted into the holes 406. With other platen designs, the insulation may be integral with the body of the platen.

In this particular example the platen is made from titanium. The insulating coating is PEEK (polyetheretherketone). Alternatives are for the platen to be made of copper, aluminium or stainless steel and for the coating to be polyxylylene film or FEP fluorocarbon.

As discussed above, the platen may not be of the form described in relation to FIGS. 2a-2d, 3a-3d and 4 and an alternative embodiment will now be described. In the alternative embodiment, the base, the insulating coating and the shield are not separable and form one complete platen. This is advantageous because the three layers can be constructed before the hollows for the solid dosage forms are formed thereby ensuring full alignment between the base and the shield. The base is typically made from aluminium, stainless steel or titanium and the shield is typically made from copper, stainless steel or titanium. In one example, which is not pharmaceutically suitable, the insulating coating is made from glass fibre reinforced polyester.

In the case where the three layers are constructed and then the hollows for the solid dosage forms are formed, the construction may comprise layering sheets of the appropriate materials or forming layers by a known coating process and then forming the hollows. The thickness of the insulating coating is selected to give an appropriately shaped electric field when the base and the shield are charged. The hollows may be formed by drilling holes through the shield and the insulating coating and partially into the base. At each hollow, the base is, for example, curved in cross section in order to receive a solid dosage form.

In the following description of the coating apparatus, it will be understood that a platen of either construction described above may be used, or indeed another construction which has not been described.

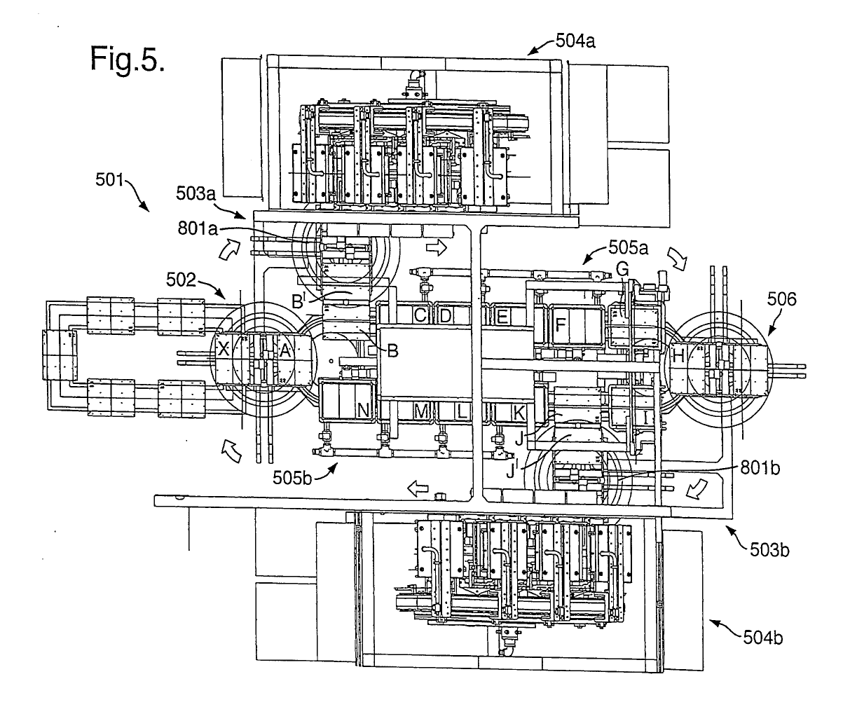

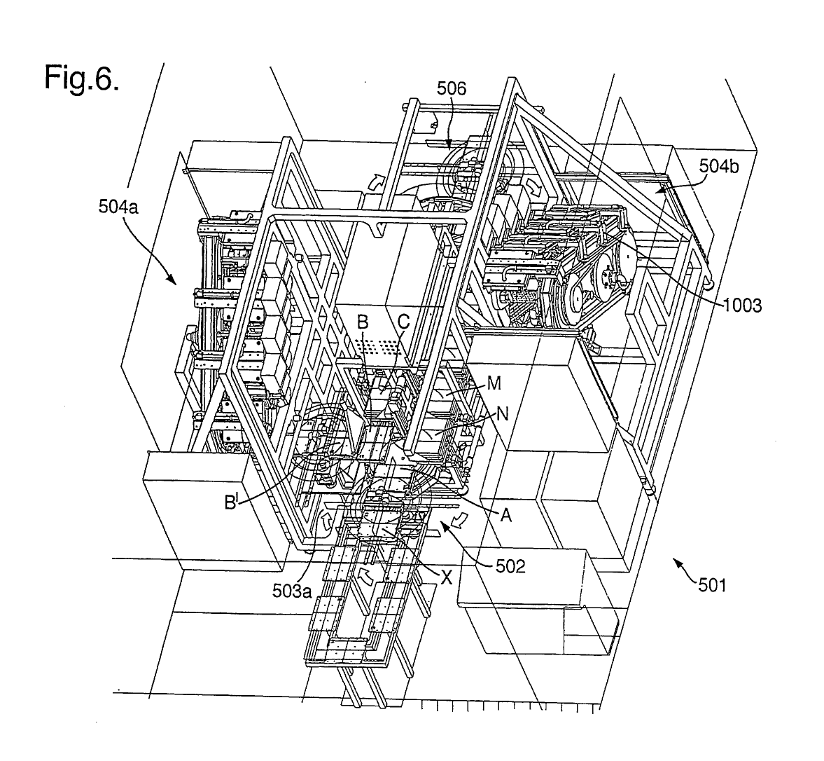

FIG. 5 is a plan view of the coating apparatus and FIG. 6 is a perspective view of the coating apparatus. The coating apparatus is generally designated 501 and incorporates apparatus for electrostatically applying a powder material to substrates, Each platen 201 carrying solid dosage forms (as previously described with reference to FIGS. 2 to 4) enters the coating apparatus at the entry and exit region 502, proceeds around the apparatus in the direction of the arrows, then exits the apparatus at the entry and exit region 502. The platens do not move smoothly through the apparatus but move from station to station in a number of individual steps. (The stations are labelled A to N in the drawings). In a particular example, a platen 201 moves forward one station every 20 seconds. It takes approximately 3 seconds to move the platen from one station to the next so a platen is stationary at a particular station for approximately 17 seconds. With this platen design and speed of operation, the apparatus produces just over 80 000 coated solid dosage forms per hour.

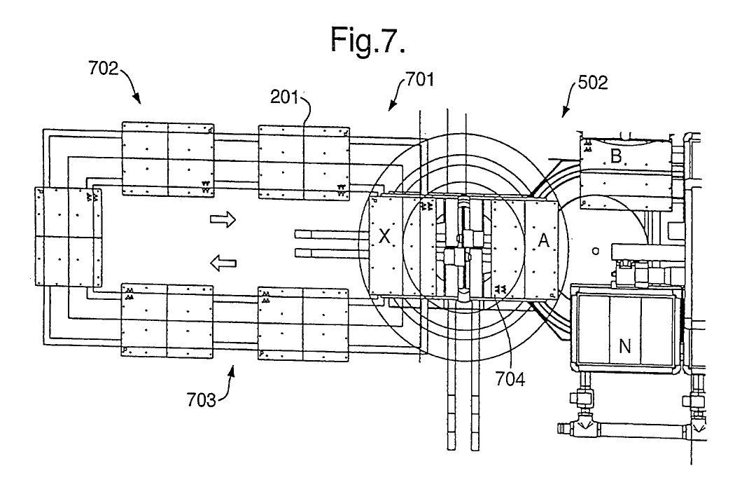

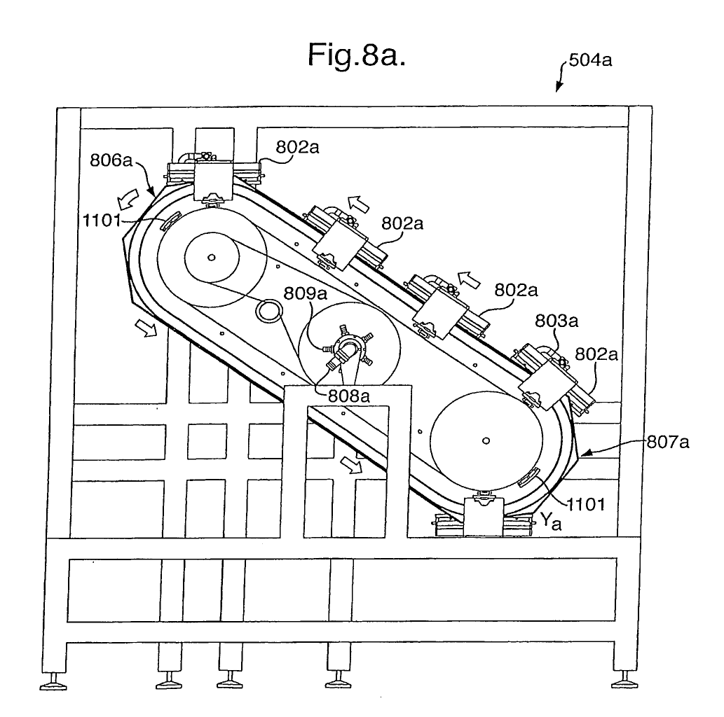

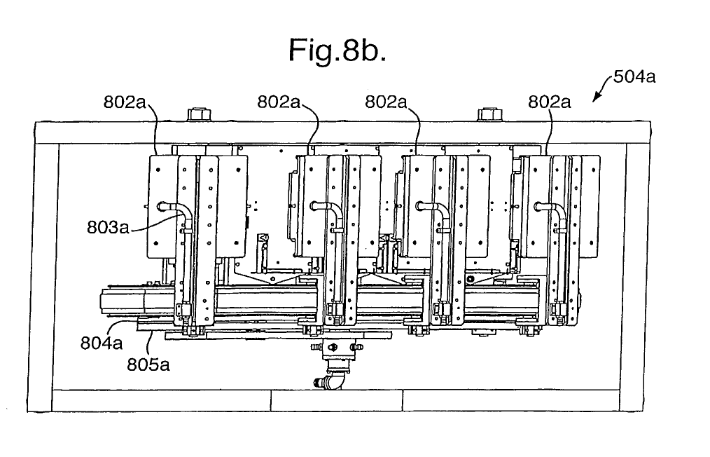

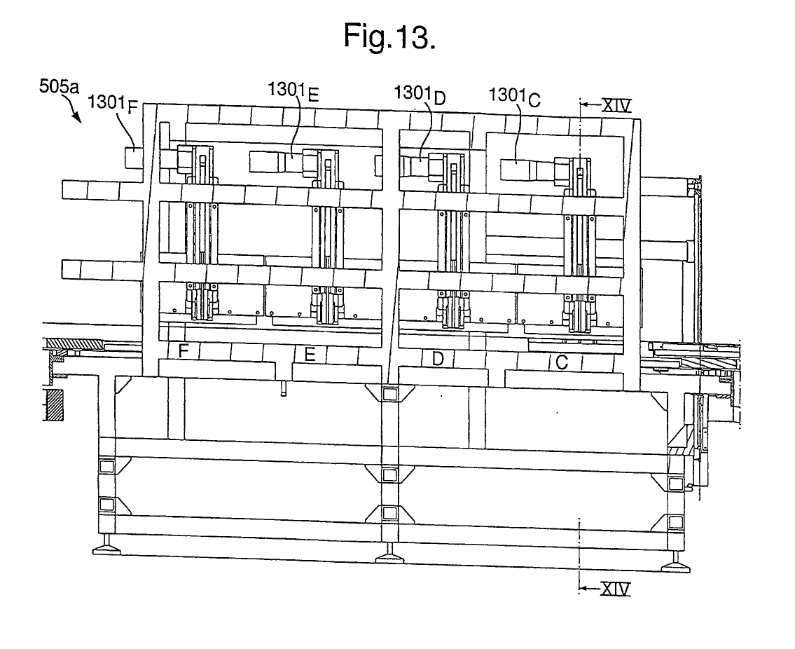

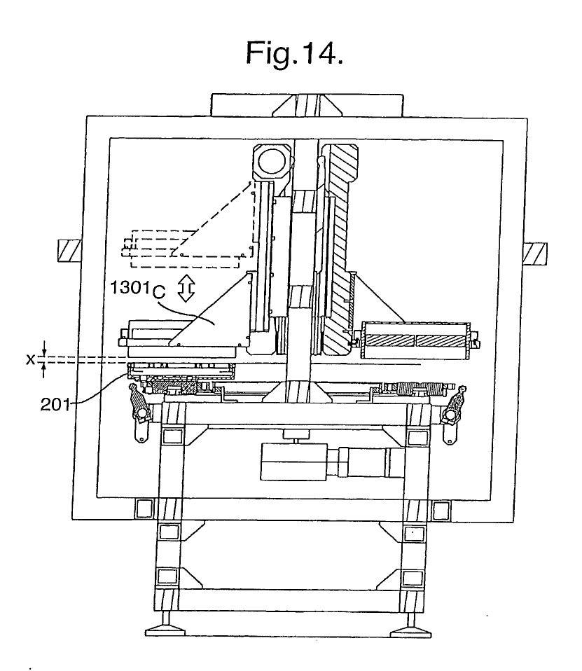

The entry and exit region is more fully described below with reference to FIG. 7. Referring to FIGS. 5 and 6, after entering the apparatus at station A, the platen 201 of solid dosage forms moves forward to station B and then is moved onto a first developing machine 504a in the region 503a. The activities in the region 503a and the first developing machine 504a will be described in more detail with reference to FIGS. 8 to 12 and include electrostatically applying powder material to the solid dosage forms. Thus the first developing machine may also be referred to as an applicator. After passing through the first developing machine 504a, the platen is moved back onto station B and then into the first fusing region 505a which comprises stations C, D, E and F on the coating apparatus 501. The activities in the first fusing region 505a will be described in more detail with reference to FIGS. 13 and 14. After the first fusing region 505a, the platen moves to the next station G. Stations G, H and I comprise an inverting mechanism 506 which allows half coated solid dosage forms to be turned over so that the second side of the solid dosage forms can be coated in the second half of the apparatus 501. The inverting mechanism 506 will be described in more detail with reference to FIGS. 15 and 16. After the inverting mechanism 506, the platen of solid dosage forms moves forward to station J and then is moved onto a second developing machine 504b in the region 503b. The second developing machine 504b is similar to the first developing machine 504a and can also be referred to as an applicator. After passing through the second developing machine 504b, the platen is moved back onto station J and then into the second fusing region 505b which comprises stations K, L, M and N on the coating apparatus 501. After the second fusing region 505b, the platen returns to station A where the platen of fully coated solid dosage forms can be exchanged for a platen of uncoated solid dosage forms as described in more detail below with reference to FIG. 7.

The entry and exit region 502 is shown in more detail in FIG. 7. Empty platens 201 are loaded with solid dosage forms 101 on the entry side 702 of the loading and unloading circuit 701. The loading and unloading circuit 701 moves in the direction of the arrows. The loading of the platen 201 with solid dosage forms is most likely performed automatically but may, of course, be performed manually. The platens are checked (either automatically or manually) to ensure that all the hollows 304 are filled with a solid dosage form 101 and that the solid dosage forms 101 are properly positioned in the hollows 304. More detail is given later on the effect when one or more of the hollows 304 are inadvertently not filled with a solid dosage form, A platen filled with solid dosage forms then moves to station X at the same time as a platen filled with coated solid dosage forms (which has already passed through the entire coating apparatus) moves to station A. The transfer table 704 then rotates through half a revolution to move the platen filled with uncoated solid dosage forms onto station A of the machine 501 and the platen filled with coated solid dosage forms onto station X of the circuit 701. The platen filled with coated solid dosage forms then moves through the exit region 703 of the circuit 701, where the coated solid dosage forms are unloaded from the platen 201. The unloading of the platen 201 is most likely performed automatically but may, of course, be performed manually. The empty platen 201 can then be reloaded with solid dosage forms 101 in the entry region 702 ready for passing through the coating apparatus again. The machinery for loading the platens with solid dosage forms and for unloading the solid dosage forms from the platens may be of any conventional kind, if those operations are performed automatically.

The operating speed of the apparatus referred to above means that rotation of the transfer table must take 17 seconds or less.

The first developing machine 504a is shown in more detail in FIGS. 8a and 8b. FIG. 8a is an elevation view of the first developing machine 504a and FIG. 8b is a plan view of the first developing machine 504a.

In some embodiments, the coating apparatus may include an additional treatment station or stations before the developing machine. This treatment station may be used to warm and dry the solid dosage forms which will be advantageous in some cases. Alternatively, the treatment station may be used to dampen the solid dosage forms which will be advantageous in other cases. Or the treatment station may be used for any treatment of the solid dosage forms which is useful to perform before the solid dosage forms are coated.

With reference to FIGS. 5, 6, 8a and 8b, the platen filled with uncoated solid dosage forms which has just moved to station A by rotation of the transfer table 704 subsequently moves forward to station B. The platen filled with uncoated solid dosage forms then moves laterally to position B′ at the same time as a platen filled with half coated solid dosage forms (which has already passed through the first developing machine 504a) moves to position Yₐ′ (not shown) of the first developing machine. The transfer table 801a then rotates to move the platen filled with uncoated solid dosage forms to position Yₐ′ of the developing machine 504a and the platen filled with half coated solid dosage forms onto position B′ of the tablet coating apparatus 501. The platen filled with half coated solid dosage forms then moves laterally to station B while the platen filled with uncoated solid dosage forms moves laterally to station Yₐ in the developing machine. The platen filled with half coated solid dosage forms is then ready to move to station C for fusing whilst the platen filled with uncoated solid dosage forms is ready to move through the developing machine 504a.

At station Yₐ, the platen is mechanically secured to a frame by movably mounted projections on the frame which are appropriately located to be movable into the holes 301, 302 and 303 on the platen to lock the platen to the frame. The frame in turn is permanently secured to and forms part of a carriage which is mounted for movement around an endless path through the developing machine 504a.

The carriage passes round the developing machine 504a in the direction of the arrows shown in FIG. 8a. In the example described, five platens are accommodated on the developing machine 504a at any one time.

As described previously, the coating of the solid dosage forms is achieved electrostatically, It is advantageous that the powder material supply be below the solid dosage form 101 such that the powder material has to move upwards towards the solid dosage form 101.

Accordingly, if the carriage 802a is to be upside down over the powder material supply, the solid dosage forms 101 must be secured to the platen 201 so that when the carriage 802a passes upside down over the powder material supply, the solid dosage forms 101 do not fall off the platen 201. In order to secure the solid dosage forms in place, the carriage 802a is attached to a vacuum pump (not shown) by vacuum pipes 803a. As mentioned previously, each hollow 304 on the platen 201 is connected to the vacuum pump by a central passageway 305 so that the solid dosage form 101 located in the hollow 304 remains in position even when the carriage 802a is upside down. In order to secure each platen 201 in place on the frame, the frame is mechanically secured to the platen 201 as mentioned previously. This securing mechanism is mechanical so that, if there were a power failure, even though the solid dosage forms 101 would fall out of the platens 201 (because the vacuum supply would fail), the platens 201 would not fall out of the frames.

The developing machine is designed to be able to operate with an empty carriage. Therefore, the vacuum connection to a carriage is designed to be closed automatically when a platen is not fixed to the frame. If that were not the case, the missing platen could result in the entire vacuum supply being ineffective and all the solid dosage forms 101 in the entire developing machine would fall off as the carriages passed over the powder material supply.

On the developing machine shown, there are four identical individual developers (not shown in FIGS. 8a and 8b, but shown schematically in FIG. 12) and each carriage 802a passes smoothly over each developer in succession. There may, of course, be a different number of individual developers on the developing machine and this will depend on the particular application. In one embodiment there are two identical developers on each developing machine. In the embodiment shown, the dimensions of the developers are fixed and the fact that, in the example described, there are four individual developers on the developing machine 504a determines the appropriate speed of the carriages which allows the solid dosage forms 101 to be in the vicinity of the powder material supply for long enough to achieve the desired coating on the solid dosage forms 101. In this example, the maximum value of v is 25 mm/second and v may be selected to be any value up to that maximum. The maximum value of v may, of course, have a different value in alternative embodiments. The developers are located 500 mm apart so that a carriage passes the developer once every 20 seconds. For a given number of developers and developer spacing, varying the speed v will clearly give a different cycle time for the entire machine 501.

The carriages 802a move steadily past the developers at a constant speed, v, which has to be appropriate for the particular coating process. Once the carriage has passed to the last developer, however, it is desirable that it is returned to the station Yₐ as quickly as possible. To achieve this, the first developing machine 504a uses two separate drive belts, the inner drive belt 804a and the outer drive belt 805a.

These can be seen in FIG. 8b. The outer belt 805a runs at a constant speed of approximately 25 mm per second and it is to this outer drive belt 805a that the carriages 802a are attached when they pass over the individual developers. The inner drive belt 804a does not run at a constant speed. In fact, the inner drive belt 804a runs at the same speed as the outer drive belt 805a only when a carriage is at the upper handover region 806a and a carriage is at the lower handover region 807a. Between these handover regions, the inner drive belt 804a moves quickly through half the circuit and then stops completely.

The movement of a carriage through the developing machine is as follows. The platen 201 enters the developing machine 504a from the coating apparatus 501 via the transfer table 801a, At this point the carriage must be stationary so that the transfer can be effected. Accordingly, the carriage is attached to the inner drive belt 804a which is stationary. Once the transfer has been completed, the inner drive belt 804a begins to move at the same speed as the outer drive belt (speed v) 805a and, while the two belts are moving at the same speed, the carriage is transferred from the inner drive belt 804a to the outer drive belt 805a in the lower handover region 807a, The carriage then passes over the individual developers at a constant speed, to the upper handover region 806a. At the upper handover region 806a, the inner drive belt 804a is running at the same speed as the outer drive belt 805a and the carriage is transferred from the outer drive belt 805a back to the inner drive belt 804a. The inner drive belt 804a then increases in speed (to speed u) and moves the carriage through the return part of the developing machine circuit quickly to the station Yₐ where the outer belt stops completely and the platen 201 can be transferred back to the coating apparatus 501 via the transfer table 801a. In this example, because the developer number and spacing is fixed, the operating speed of the apparatus provides that a platen moves forward by one station every 20 seconds. The outer drive belt 805a therefore completes a full circuit of the developing machine every 40 seconds.

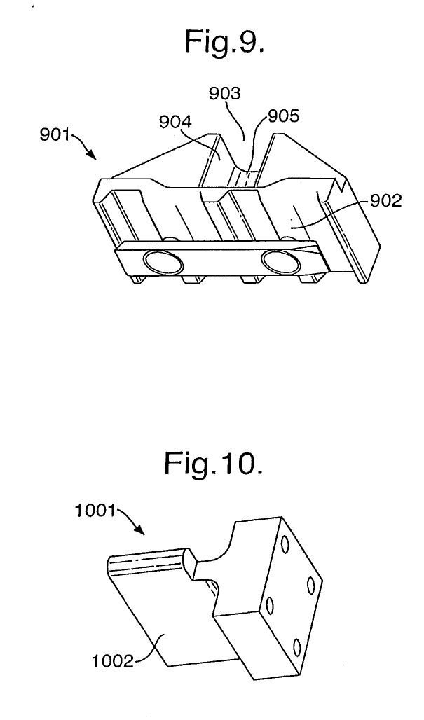

It will be understood that there are two carriage positions on the inner drive belt 804a and that while the two drive belts are running at the same speed, a carriage is being transferred from the inner drive belt 804a to the outer drive belt 805a in the lower handover region 807a and simultaneously a carriage is being transferred from the outer drive belt 805a to the inner drive belt 804a in the upper handover region 806a. Thus, at any one time, there are four carriages on the outer drive belt 805a and one carriage on the inner drive belt 804a. The transfer mechanism for transferring the carriages between the two belts in the upper and lower handover regions 806a, 807a is described in more detail with reference to FIGS. 9, 10, 11a and 11b.

FIG. 9 is a perspective view of a belt flight 901. Two belt flights 901 are fixed to the inner drive belt 804a and are equally spaced from one another. Eight belt flights 901 are fixed to the outer drive belt 805a and are equally spaced from one another around the drive belt. The belt flight 901 has an underside 902 which is in contact with the surface of the appropriate drive belt. In this example, the drive belt surface is toothed and the belt flight 901 is correspondingly shaped so that when the belt flight fits onto the drive belt, risk of relative movement of the belt flight and the drive belt is substantially eliminated.

The belt flight 901 includes a U-shaped opening 903 having two side walls 904 and an outer wall 905. The belt flights 901 on the outer drive belt 805a are positioned such that the outer wall 905 is on the outer side of the drive belt. The belt flights 901 on the inner drive belt are positioned such that the outer wall 905 is on the inner side of the drive belt.

FIG. 10 is a perspective view of a belt changer 1001. A belt changer 1001 is located on each carriage and is movable laterally with respect to the carriage. Each belt changer blade 1001 includes a belt transfer blade 1002 which is shaped to engage with the U-shaped opening 903 on a belt flight 901.

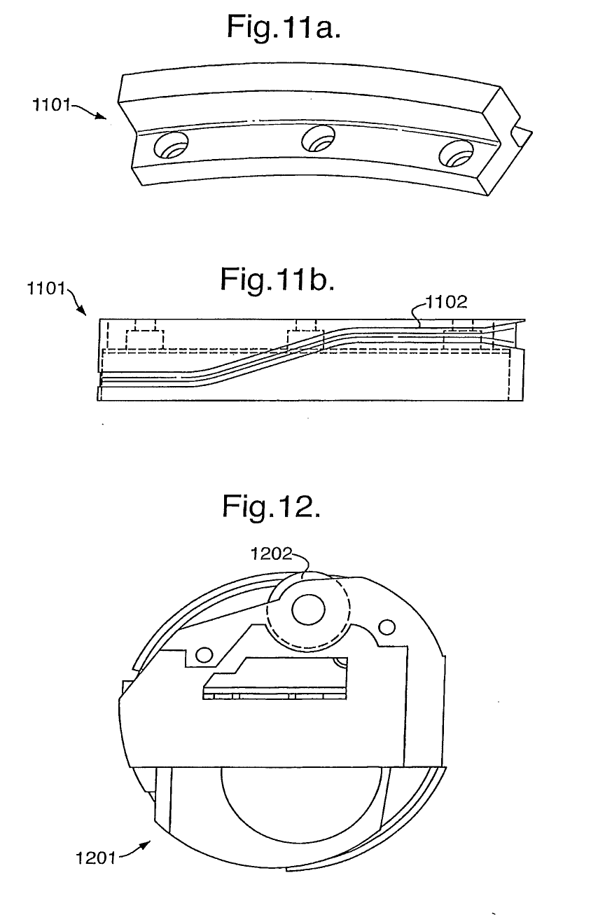

FIG. 11a is a perspective view of a belt transfer block 1101 and FIG. 11b is a plan view of the belt transfer block 1101. The belt transfer block 1101 is curved at a radius of curvature which matches that of the inner and outer drive belts 804a, 805a at the upper and lower handover regions 806a, 807a. In FIG. 8a, a belt transfer block 1101 can be seen in the upper handover region 806a and a second belt transfer block 1101 can be seen in the lower handover region 807a, Each belt transfer block 1101 includes a belt transfer track 1102. Each carriage incorporates an inwardly projecting spike-like cam follower (not shown) which is arranged to engage in the belt transfer track 1102 as the carriage moves through the upper or lower handover regions 806a, 807a, In the lower handover region 807a, as the cam follower engages in the belt transfer track 1102, it moves laterally outward; in the upper handover region 806a, as the cam follower engages in the belt transfer track 1102, it moves laterally inward.

The movement of the carriage around the developing machine 504a is as follows. When the carriage is on the inner drive belt 804a, the belt transfer blade 1002 of the belt changer 1001 on the carriage is engaged with the U-shaped opening 903 on one of the belt flights 901 fixed to the inner drive belt 804a. Thus, the relative positions of the inner drive belt, the belt flight and the carriage are fixed. When the carriage is at the lower handover region 807a, the inner and outer drive belts 804a, 805a are temporarily moving at the same speed and a belt flight 901 on the outer drive belt 805a is aligned with a belt flight 901 on the inner drive belt 804a. The cam follower on the carriage engages in the belt transfer track 1102 on the belt transfer block 1101 in the lower handover region and this causes the belt transfer blade 1002 of the belt changer 1001 on the carriage to move laterally outward. As this occurs, the belt transfer blade 1002 moves from being engaged with the U-shaped opening 903 of the belt flight 901 on the inner drive belt 804a to being engaged with the U-shaped opening 903 of the belt flight 901 on the outer drive belt 805a. The carriage is now on the outer drive belt 805a and the relative positions of the outer drive belt, the belt flight and the carriage are fixed.

Then, the carriage moves to the upper handover region 806a at a constant speed whilst fixed to the outer drive belt 805a.

When the carriage is at the upper handover region 806a, the inner and outer drive belts 804a, 805a are again temporarily moving at the same speed and a belt flight 901 on the inner drive belt 804a is aligned with a belt flight 901 on the outer drive belt 805a. The spike-like cam follower on the carriage engages in the belt transfer track 1102 on the belt transfer block 1101 in the upper handover region 806a and this causes the belt transfer blade 1002 of the belt changer 1001 on the carriage to move laterally inward. As this occurs, the belt transfer blade 1002 moves from being engaged with the U-shaped opening 903 of the belt flight 901 on the outer drive belt 805a to being engaged with the U-shaped opening 903 of the belt flight 901 on the inner drive belt 804a. The carriage is now once again on the inner drive belt 804a and the relative positions of the inner drive belt, the belt flight and the carriage are fixed. Then, the carriage moves, whilst fixed to the inner drive belt 804a, toward station Yₐ of the developing machine, ready to move to station C for fusing.

Because the belt transfer blade 1002 and cam follower on each carriage are moveable laterally with respect to each carriage, as the carriages move around the developing machine 504a, they remain in the same lateral position with only the belt transfer blades 1002 and the spike-like cam followers moving in the lateral direction. As mentioned previously, the belt flights 901 are positioned on the outer drive belt 805a such that the outer wall 905 is on the outer side of the drive belt and the belt flights 901 are positioned on the inner drive belt 804a such that the outer wall 905 is on the inner side of the drive belt. Thus, the two outer walls 905 of belt flights 901 on the two drive belts define the limits of the path of the belt transfer blade 1002 as it moves between the belt flights 901.

As mentioned previously, the solid dosage forms 101 are secured by a vacuum supply to the platen 201 as the carriages pass over the developers. In fact, the carriages are connected to the vacuum supply via vacuum pipes 803a during the entire circuit of the developing machine 504a, The vacuum supply system must therefore rotate with the carriages 802a as they move around the developing machine 504a. This can be seen in FIG. 8a. The main vacuum supply pipe 808a is fixed and the separate connector pipes 809a are rotatable with respect to the vacuum supply pipe 808a. As described above, the carriages do not move round the developing machine circuit at a constant speed. Therefore, the speed of rotation of the vacuum supply drive belt 810a is intermediate between the fastest speed of the inner drive belt 804a (speed u—when the carriages are between the upper and lower handover regions 806a, 807a) and the constant speed v of the outer drive belt 805a. In addition, the pipes (not shown) between the separate connector pipes 809a and the vacuum pipes 803a on each carriage are fairly slack to allow for this speed variation. As will be understood, the vacuum supply drive belt completes one revolution in the same time as a carriage completes one complete cycle of operations.

An individual developer 1201 is shown schematically in FIG. 12. The developer is of known type. In the example, there are four such individual developers on each developing machine 504a, 504b. Each developer 1201 includes a store of powder material and is arranged to feed the powder material to a roller 1202 that is electrically conducting and is connected to a voltage source (not shown). Powder material in the developer 1201 is fed to the roller 1202 and is charged triboelectrically during its passage to the roller 1202.

Once the platen of solid dosage forms has passed through the first developing machine 504a and has exited via the transfer table 801a, the platen of half coated solid dosage forms is ready to move on to the first fusing region 505a.

The first fusing region 505a comprises stations C, D, E and F on the coating apparatus 501 and is shown in more detail in FIGS. 13 and 14.

In the first fusing region 505a, the powder material that has been deposited onto the exposed surfaces of the solid dosage forms 101 in the first developing machine 504a, is fused. The powder material includes a component which is fusible to form a continuous film coating. Advantageously, the powder material includes a CO-containing component. Suitable CO-containing components are, for example, polyacrylates, for example polymethacrylates; polyesters; polyurethanes; polyamides, for example nylons; polyureas; polyvinylpyrrolidone and copolymers of vinylpyrrolidone with other suitable monomers, e.g. vinyl acetate; biodegradable polymers, for example polycaprolactones, polyan hydrides, polylactides, polyglycolides, polyhydroxybutyrates and polyhydroxyvalerates; polysaccharides, for example cellulose esters; hydrophobic waxes and oils, for example vegetable oils and hydrogenated vegetable oils (saturated and unsaturated fatty acids), e.g. hydrogenated castor oil, carnauba wax, and beeswax. Other (non-CO-containing) fusible components which may be present with or instead of CO-containing components are, for example, cellulose ethers; sugar alcohols, for example lactitol, sorbitol, xylitol, galactitol and maltitol; sugars, for example sucrose, dextrose, fructose, xylose and galactose; hydrophilic waxes; and polyethylene glycol. One or more fusible materials may be present. Preferred fusible materials generally function as a binder for other components in the powder.

Examples of CO-containing polymer binders (also referred to as resins) include polyvinylpyrrolidone, hydroxypropyl methylcellulose phthalate, hydroxypropyl methylcellulose acetate succinate, and methacrylate polymers, for example an ammonio-methacrylate copolymer, for example those sold under the name Eudragit. The use of such binders with, for example, xylitol or other sugar alcohol, for example to promote solubility when the polymer binder is insoluble, should especially be mentioned.

More especially, the fusible material of the coating comprises a blend of a polyvinyl pyrrolidone and a polyacrylate (water-soluble), or comprises a methyl methacrylate-based polymer or copolymer. The CO-containing coating materials mentioned above may be used, for example, with substrates containing lactose or other sugars, or sugar alcohol or cellulose-based fillers, or based on mineral fillers, e.g. dicalcium phosphate.

Thus, the powder may comprise, for example, binder and optionally one or more further materials selected from other fusible material, colorant, opacifier, dispersant, charge-control agent, disintegrant, wax, plasticiser, taste modifier, and filler. The powder material may also include a flow aid present at the outer surface of the powder particles.

Fusing of the powder material is achieved by exposing the powder material to a radiant heat source for sufficiently long to fuse the material. In practice that is likely to require a time period of more than 20 s and it is therefore convenient to have more than one fusing station. In this particular example there are four stations. Thus, the first fusing region 505a comprises four stations C, D, E and F.

FIG. 13 shows the first fusing region 505a comprising the four stations C, D, E and F. Aligned with each fusing station is a fusing device or fuser 1301. The four fusers 1301_{C}, 1301_{D}, 1301_{E} and 1301_{F} are identical. Fusing station C and the associated fuser 1301_{C} will now be described with reference to FIG. 14; it should be understood that operation of the fusing stations D, E and F is identical to the operation of fusing station C.

FIG. 14 is a sectional view of the first fusing station C along the line XIV on FIG. 13. A platen 201 (containing half coated solid dosage forms (not shown)) is located at station C. The fuser 1301_{C} containing a heat source (typically a ceramic element, not shown) is positioned at a distance x from the platen 201. In this example, x is 50-70 mm. The fuser 1301_{C} is movable in the direction shown by the double headed arrow. Thus, x can be varied depending on the particular solid dosage form and powder material. In addition, the fuser 1301_{C} is biased to return to its top position (shown by dotted lines) i.e. where x is maximised. This means that, if there were a power failure, the fuser 1301_{C} would automatically return to its top position ensuring that the solid dosage forms in the platen 201 would not burn. (If there were a power failure, the heat source on the fuser would not cool immediately and the solid dosage forms may overheat as a result.)

A platen 201 moves forward to the next station every 20 seconds. As previously mentioned, it takes approximately 3 s to move the platen between stations. Thus, the platen 201 is at fuser station C for 17 s, moving forward for 3 s, at fusing station D for 17 s, moving forward for 3 s and so on. Once the platen has passed through the entire first fusing station 505a, the powder material on the solid dosage form 101 is completely fused and the solid dosage form 101 is ready to be turned over, so that it can be coated on the opposite side. That process is described below.

In some embodiments, the coating apparatus may include an additional station or stations after the fusing station to allow the fused coating and the solid dosage forms to cool. The cooling may be achieved with cool air driven by a fan, for example.

It has been found that for some solid dosage forms, as the solid dosage form is heated in order to fuse the powder material, bubbles of gas are formed in the solid dosage form and those bubbles rise to the surface of the solid dosage form, and bubble through the partially fused powder material, causing an uneven surface effect on the resulting coated solid dosage form. In order to solve this problem, each fusing station C, D, E and F is attached to the vacuum supply as previously described with reference to the first developing machine 504a. As bubbles of gas form in the solid dosage form 101 they move towards the platen 201 rather than towards the powder material which is being fused, thereby avoiding any bubbling of the powder material being fused and ensuring a smooth surface coating for the solid dosage form. Each fusing station C, D, E and F is connected to the vacuum supply whilst a platen is located at that station. When the platens are moving between stations, the vacuum supply is temporarily disconnected from the fusing stations.

Once the platen 201 of solid dosage forms 101 has passed through the entire first fusing station 505a, the solid dosage forms 101 are ready to be turned over so that the opposite sides of the solid dosage forms 101 can be coated. This is done in the inverting mechanism 506 which comprises stations G, H and I of the apparatus 501 and is shown in detail in FIGS. 15 and 16.

FIG. 15 is a plan view of the inverting mechanism 506 and shows stations G, H and I. FIG. 16 is a perspective view of stations G and H of the inverting mechanism.

Half coated solid dosage forms on a platen 201 enter station G from the last fusing station F. The platen 201 is secured in a first frame 1501. A second frame 1502 holding an empty platen 201 is located at station I. An empty platen is also located at station H. The first frame 1501 and the second frame 1502 are connected to an arcuate rail 1503 and are arranged to run on the arcuate rail so as to rotate about a horizontal axis, moving along a path in a vertical plane defined by the arcuate rail. As they rotate, the frames remain perpendicular to the arcuate rail (i.e. the frames always lie along the radial direction).

The steps of the inverting process are as follows:
1) The second frame 1502 containing an empty platen 201 rotates around the arcuate rail 1503 until it is located upside down at station G on the first frame 1501 which contains a platen 201 of half coated solid dosage forms.
2) Both frames 1501, 1502 rotate together along the arcuate rail 1503 until the second frame 1502 is located at station I with the first frame 1501 upside down at station I on the second frame 1502. At this point most of the solid dosage forms will have already fallen from the hollows 304 in the platen 201 in the first frame 1501 into the hollows 304 in the platen 201 in the second frame 1502.
3) At this point, the two frames 1501, 1502 are vibrated. This has the effect that any solid dosage forms remaining in the platen 201 in the first frame 1501 fall into the platen 201 on the second frame 1502 and any solid dosage forms which are misaligned or unevenly positioned in the platen 201 in the second frame 1502 will become correctly positioned. In this particular example, the vibration is carried out at mains frequency i.e. at 50 Hz.
4) Finally, the first frame 1501 containing a now empty platen 201 rotates along the arcuate rail 1503 back to station G.

Steps 1) to 4) take place in 17 seconds or less so that once the inverting process has been completed, the platens are ready to move forward to the next station. At this point, a platen of half coated solid dosage forms moves from fusing station F to station G. The now empty platen in the first frame 1501 at station G moves forward to station H. The empty platen at station H moves forward to station I. The platen of half coated solid dosage forms (which have just been turned over in the inverting mechanism) at station I moves forward to station J.

Then steps 1) to 4) are repeated. In this process the empty platen which was at station H is used as the empty platen in the second frame 1502 at station I. The now empty platen which was in the first frame 1501 is now located at station H. Once the inverting process has been completed once again, the platens are ready to move forward to the next station. At this point, a platen of half coated solid dosage forms moves from fusing station F to station G. The now empty platen in the first frame 1501 at station G moves forward to station H. The empty platen at station H (which was previously in the first frame 1501) moves forward to station I. The platen of half coated solid dosage forms (which have just been turned over in the inverting mechanism) at station I moves forward to station J. Thus, a platen which is filled with half coated solid dosage forms and moves from station F to station G is reused two stations later as the empty platen for that inverting process.

As mentioned previously, various platen designs are possible. In this example, the solid dosage forms have two domed end surfaces 103 and a circumferential surface 102. When the solid dosage forms are coated in the developing machine, all exposed surfaces are coated with the powder material. If it is desired, for example, in the first developing machine 504a for only one domed end surface 103 to be coated and in the second developing machine 504b for both the other domed end surface 103 and the circumferential surface 102 to be coated, there must be different platen arrangements in each developing machine. For example, the platens in the first developing machine 504a may have relatively deep hollows 304 such that only one domed end surface 103 of each solid dosage form 101 is exposed for coating; the platens in the second developing machine 504b may have relatively shallow hollows 304 such that the second domed end surface 103 and the circumferential surface 102 is exposed for coating. An example of where such an arrangement may be useful is if one domed end surface 103 is to be coated with a first colour of powder material and the second domed end surface 103 and the circumferential surface 102 is to be coated with a second colour of powder material. In a case where different platen arrangements are used, the appropriate platens are swapped at station H of the inverting mechanism. Such a swapping mechanism is described below.

When the inverting process (steps 1) to 4) above) is being performed at stations G and I, the empty platen at station H is not in use. During this time, the empty platen of first design at station H can be swapped for an empty platen of second design at station Z. This is done by rotation of the transfer table 1504. The empty platen of first design can then be moved to the entry region 702 of the loading and unloading circuit 701 at the entry and exit region 502 so that it can be reused. The platens of second design which are exiting the machine at the exit region 703 of the loading and unloading circuit 701 at the entry and exit region 502 can be moved to the swapping mechanism to be reused. Thus one side of the machine 501 (stations B to G) uses platens of a first design and the other side of the machine 501 (stations I to N) uses platens of a second design.

As an alternative to, or in addition to, varying the depths of the hollows 304, it is possible to alter the position of the shield 203 on the base 202 of the platen to alter the spacing of the shield from the base and obtain a different platen arrangement in that way.

Such a swapping mechanism may also be useful even when the platen design is the same on both sides of the machine 501. The empty platen at station H can be swapped for a second empty platen at station Z. This is useful so that the platen can be checked to ensure that all the half coated solid dosage forms have been successfully transferred in the inverting process. Any solid dosage forms remaining in the platen can be removed and the platen can be checked so that it is clean and ready to be reused. This checking and cleaning may be done automatically or manually.

As mentioned above, as the platens enter the coating apparatus, they are checked to ensure that each hollow 304 is filled with a solid dosage form. It is, of course, preferable that every hollow is filled with a solid dosage form because, since the platen base is earthed like the solid dosage forms, the powder material will be attracted onto the base itself and then may be fused onto the base. This should be avoided. Therefore, on entry to the coating apparatus, there is included a sensor which senses whether one or more hollows in a platen are empty. This sensor may be, for example, a light sensor or a camera, or any other type of known sensor suitable for this purpose. If the sensor detects an empty hollow, the platen will pass through the coating apparatus but, at each treatment station, the treatment will be disabled. For example, when the platen is at the first fusing station C, the fuser 1301_{C} is returned to its top position (shown by dotted lines in FIG. 14). Similarly, fusers 1301_{D} 1301_{E} and 1301_{F} will be returned to their top positions as the platen passes through stations D, E and F. In this way, the powder material may coat the empty hollow, but will not be fused onto the shield. After the solid dosage forms have been removed from the platen at the inverting mechanism, at station H the platen can be swapped for a new clean platen at station Z. The platen can be cleaned of any powder material and used again later.

Once the solid dosage forms have been turned over, they move forward to station J. They then move onto the second developing machine 504b. The second developing machine 504b is identical to the first developing machine 504a so will not be described in detail. Identical parts are designated by the same reference numerals with suffix b rather than suffix a.

The platen 201 filled with turned over half coated solid dosage forms which has just moved to station J then moves laterally to position J′ at the same time as a platen filled with fully coated solid dosage forms (which has already passed through the second developing machine 504b) moves to position Y_{b}′ (not shown) of the second developing machine 504b. The transfer table 801 b then rotates to move the platen filled with half coated solid dosage forms to position Y_{b}′ of the developing machine 504b and the platen filled with fully coated solid dosage forms onto position J′ of the coating apparatus 501. The platen filled with fully coated solid dosage forms then moves laterally to station J while the platen filled with half coated solid dosage forms moves laterally to station Y_{b} in the developing machine. The platen filled with half coated solid dosage forms is ready to move through the second developing machine 504b whilst the platen filled with fully coated solid dosage forms is then ready to move to station K for fusing.

The second fusing region 505b comprises stations K, L, M and N on the apparatus 501. The second fusing region 505b is identical to the first developing machine 505a and will not be described in detail. Identical parts are designated by the same reference numerals with suffix b rather than suffix a.

Once the platen of solid dosage forms has passed through the entire second fusing region 505b, the solid dosage forms are fully coated and ready to exit the apparatus 501. The platen 201 moves from the last fusing station N back to station A. The transfer table 704 then rotates to move the platen filled with solid dosage forms onto station A of the apparatus 501 and the platen filled with coated solid dosage forms onto station X of the loading and unloading circuit 701. The platen filled with coated solid dosage forms then moves through the exit region 703 of the circuit 701, where the coated solid dosage forms are unloaded from the platen 201. The empty platen 201 can then be reloaded with solid dosage forms 101 in the entry region 702 ready for passing through the apparatus once again. Alternatively, if two designs of platen are being used (as mentioned previously in relation to the inverting mechanism), the empty platen can be moved to the swapping region for re-entry to the apparatus at station H.

The invention having been described with reference to certain specific embodiments, it will be understood that these do not limit the scope of the appended claims.

What is claimed:

1. An apparatus for electrostatically applying a powder material to substrates, the apparatus comprising,
a plurality of platens, each platen being arranged to hold a plurality of substrates, wherein each platen comprises:
an electrically conducting platen base having a plurality of supports for supporting a plurality of substrates;
an electrically conducting platen shield located on the platen base and having a plurality of holes arranged to align with the plurality of supports on the platen base; and
an insulating coating provided between the platen base and the platen shield;
a conveyor for conveying the platens along a path, and
an applicator for applying the powder material to the substrates.

2. An apparatus for electrostatically applying a powder material to substrates, the apparatus comprising,
a plurality of platens, each platen being arranged to hold a plurality of substrates, wherein each platen comprises:
a platen base having a plurality of supports for supporting a plurality of substrates, an electrically conducting platen shield located on the platen base and having a plurality of holes arranged to align with the plurality of supports on the platen base; and
an insulating coating provided on holes in the platen shield;
a conveyor for conveying the platens along a path, and
an applicator for applying the powder material to the substrates.

3. A platen for holding a plurality of substrates to which powder material is to be electrostatically applied, the platen comprising:
a platen base having a plurality of supports for supporting a plurality of substrates and an electrically conducting platen shield located on the platen base and having a plurality of holes arranged to align with the plurality of supports on the platen base.

4. A platen according to claim 3, in which the base of the platen is electrically conducting and an insulating coating is provided between the platen base and the platen shield.

5. A platen according to claim 3, in which an insulating coating is also provided on the holes in the platen shield.

6. A platen according to claim 5, in which the insulating coating is provided by insulating rings located in the holes in the platen shield.

7. A platen according to claim 5, in which the insulating coating is integral with the platen.

8. A platen according to claim 3, in which the shield is adjacent to but slightly spaced from the platen base and the spacing of the shield from the platen base is adjustable.

9. A platen according to claim 3, in which the supports are connectable to a common low pressure source for retaining the substrates on the supports.

10. A platen according to claim 3, in which each support is defined by a respective hollow in a face of the platen base.

11. A platen according to claim 10, in which a passageway extends from each hollow for connecting the support to a low pressure source.
